(19) United States
(12) Patent Application Publication
(10) Pub. No.: US 2003/0002084 A1
(43) Pub. Date: Jan. 2, 2003

(54) Auto fax sending and management system and method

(76) Inventors: Kuang-Shin Lin, Taipei (TW); Sayling Wen, Taipei (TW); Kai-Sheng Zhang, Tianjin (CN)

Correspondence Address: BIRCH STEWART KOLASCH & BIRCH, PO BOX 747, FALLS CHURCH, VA, 22040-0747, US

(21) Appl. No.: 10/183,155

(22) Filed: Jun. 28, 2002

(30) Foreign Application Priority Data
Jun. 29, 2001 (TW) 90115896

(51) Int. Cl. H04N 1/00

(52) U.S. Cl. 358/400

(57) ABSTRACT

An auto fax sending and management system and method is disclosed. It is a utility that can operate with different OS's. A user needs only to execute a signal action to complete a given operation through the UOI provided by the invention. The invention can also perform fax sending, receiving and monitoring, achieving the goal of automatic fax sending and management. The disclosed method includes the steps of initiating a one-touch OS, running the fax controlling mechanism to perform analyses, selecting a fax sending procedure through the fax controlling mechanism, preparing a fax document, receiving editing messages by the user using an editing module, prompting the user to enter a fax number and relevant information and preview them, and sending the fax through a communications module.

### BACKGROUND OF THE INVENTION

1. Field of the Invention

The invention relates to an operating system. More specifically, it relates to a system and method that can operate with different OS's (Operating System) and have both fax sending and management functions.

2. Related Art

With the increase in computer popularity, people often need to use computers to solve problems either at work or at home. But there are some causes that still produce the difficulty for people to use the fax software packages. One can see the causes in the following points:

1. Existing personal computer OS's (Operating System), such as MS Windows or Linux, are complicated despite their powerful functions and designs. Moreover, user interface designs are not intuitive and simple enough. This situation scares people without any computer background because of the obstacles they meet while using these systems.

2. Fax software packages all include editing, browsing, sending, receiving, and management functions. Conventional fax software packages usually use a parallel (random) method to group the above functions together and provide them to the user. They are more complicated in operations and uses and generally assume that users have some familiarity with the system.

Because of the above, it is highly desirable to have a simple and convenient OS to solve these problems and to provide a WYSIWYG (What-You-See-Is-What-You-Get) operating interface.

### SUMMARY OF THE INVENTION

In view of the foregoing, the invention provides an auto fax sending and management system and its method. The system is based on a one-touch OS. Two objectives of the disclosed system are:

1. to use a finite number of keys as hot keys to achieve the operation of various functions so that these functions can be initiated by a single key, thus providing convenience and intuition of operation in order to increase users' interest in using the computer;

2. to provide a method that simulates real automatic fax sending and management, so that by following the one-touch principle a user can select one of the functions to perform operations in the utility modules, thus implementing the WYSIWYG and WYDIWYG (What-You-Do-Is-What-You-Get) principles.

The invention summarizes the above-mentioned situations occurring in practice and provides several ways to send out faxes. It systematically organizes editing, reading and sending, and simplifies the user's operations. Thus, the invention provides great help for users unfamiliar with computers. Based upon the above features, any computer in which the auto fax sending and management system is installed can facilitate fax sending. This provides extra value to computers, further promoting their sales.

The disclosed method includes the steps of initiating a one-touch OS, running the fax controlling mechanism to perform analyses, selecting a fax sending procedure through the fax controlling mechanism, preparing a fax document, receiving editing messages by the user using an editing module, prompting the user to enter a fax number and relevant information and preview them, and sending the fax through a communications module.

### BRIEF DESCRIPTION OF THE DRAWINGS

The invention will become more fully understood from the detailed description given herein below. However, the following description is for purposes of illustration only, and thus is not limitative of the invention, wherein:

FIG. 1 shows a system structure of the disclosed fax sending and management system;

FIG. 2 shows a fax event flowchart for the disclosed fax sending and management system;

FIG. 3-a shows a control flowchart of sending a fax according to the disclosed auto fax sending and management method; and

FIG. 3-b shows a control flowchart of sending a fax according to the disclosed auto fax sending and management method.

### DETAILED DESCRIPTION OF THE INVENTION

The invention proposes an auto fax sending and management system and method. In particular, it provides a simple and intuitive UOI (User Operating Interface) 10 for currently complicated OS's. The user is able to complete an operation by simply pressing a single hot key. Through a network connection, the user can use the one-touch OS 100 to achieve fax sending and management.

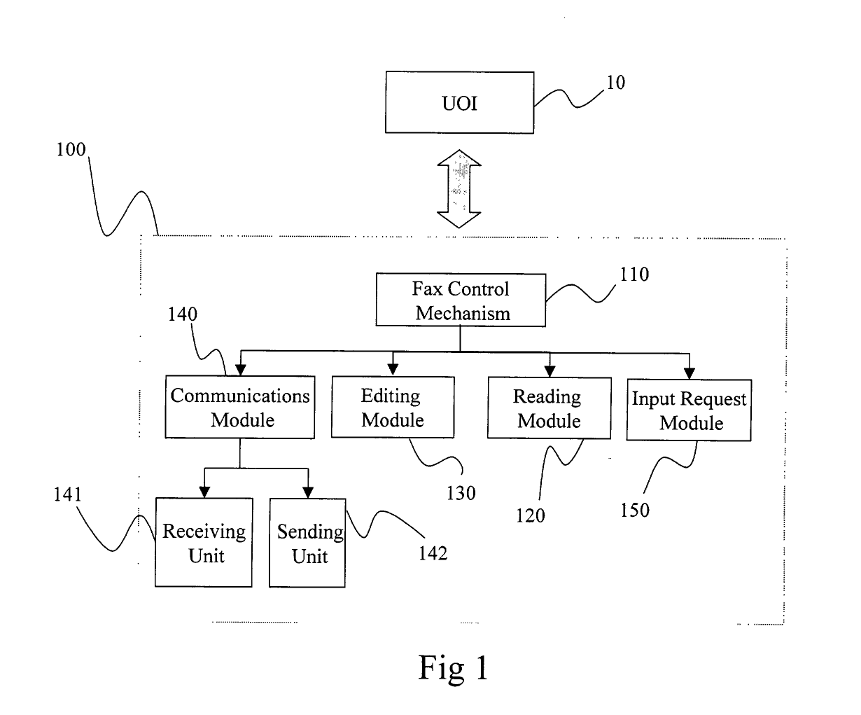

A preferred embodiment is provided below to explain the feasibility of the invention. With reference to FIG. 1, the disclosed auto fax sending and management system processes reading, editing, and browsing of faxes using the one-touch OS 100. Through the UOI 10, at least one work group is produced. By clicking functions in the work group, the user can perform various fax operations, such as “EDIT FAX”, “READ FAX”, and “FAX COMMUNICATIONS”. When the user enters a fax control mechanism 110 provided by the one-touch OS 100, the system starts a specific procedure. The fax control mechanism 110 includes: (1) a reading module 120; (2) an editing module 130; (3) a communications module 140; and (4) an input request module 150.

1. The reading module 120 displays all received fax message on the screen of the computer. The user can browse and read the messages by clicking each of them.

2. The editing module 130 decodes received fax messages or encodes fax messages to be sent. The user can modify or edit the contents of the fax message.

3. The communications module 140 is a communications interface between the fax control mechanism and the external environment. A server containing a receiving unit 141 and a sending unit 142 is used to receive and send the fax messages.

a) The receiving unit 141 receives fax messages sent from other users and initiates the editing module 130 to decode the messages.

b) The sending unit 142 sends fax messages in the fax control mechanism and initiates the editing module 130 to encode the messages.

4. The input request module 150 allows the user to select contents of the fax messages to be sent using other programs. After the encoding process, this module sends out the fax through the sending unit 142.

The one-touch OS 100 refers to an OS that enables a user to complete functions provided in the work group and displayed on the UOI 10 with one action. The work group is comprised of at least one function item. The one-touch OS 100 can existent within other OS's or alone. The user can choose to switch between the different OS's.

The one-touch OS 100 can run on any computer controlled hardware platform, such as a PC (Personal Computer), an NB (Notebook), or a PDA (Personal Digital Assistant). Any individual skilled in the art can make various modifications to implement the disclosed fax control mechanism 110 in any electronic device that can establish communication with a network.

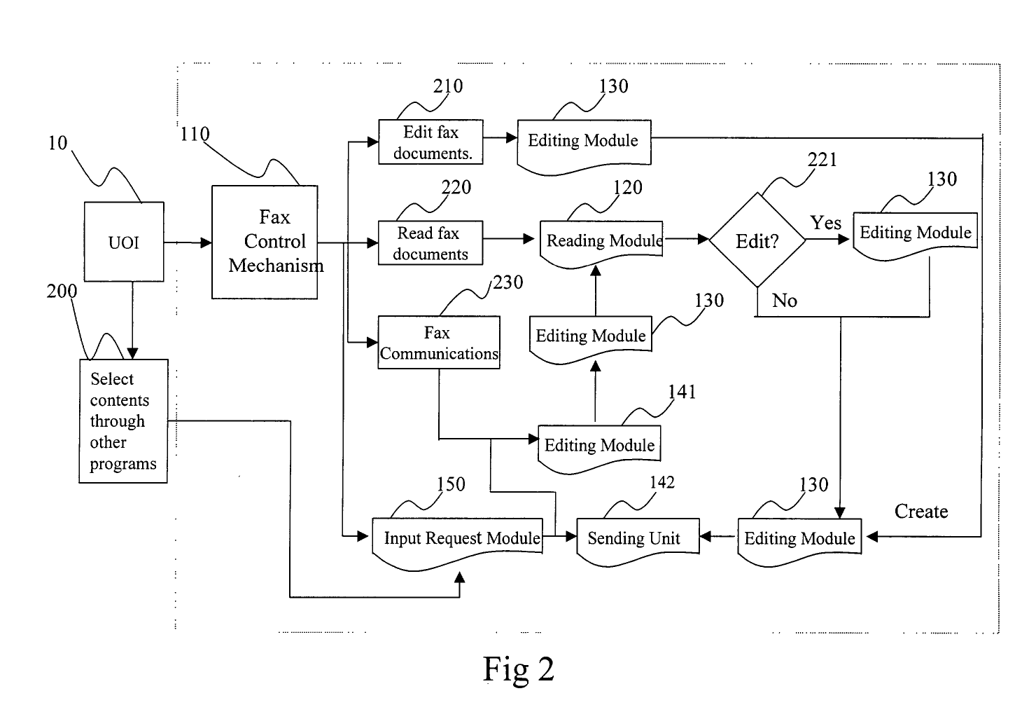

With reference to FIG. 2, there are two ways that a user can manipulate the UOI 10: (1) select contents using another program (step 200) and, after processing by the input request module 150 in the fax control mechanism 10, complete the fax operation event through the sending unit; (2) directly select a fax operation event through the fax control mechanism 10, which includes “EDIT FAX” (step 210), “READ FAX” (step 220), and “FAX COMMUNICATIONS” (step 230). When “EDIT FAX” (step 210) is selected, the editing module 130 is initiated to edit the contents of the fax document. Afterwards, the editing module uses its encoding function to perform encoding. Finally, the sending unit 142 sends out the fax document. When “READ FAX” (step 220) is selected, the user browses the fax document using the reading module 120 and determines whether editing is necessary (step 221). If it needs editing, the editing module 130 is then used to edit the contents of the fax document. Afterwards, the editing module uses its encoding function to perform encoding, and, finally, the sending unit 142 sends out the fax document. If the fax document does not need editing, the editing module performs encoding directly, and the sending unit 142 sends out the fax document. When “FAX COMMUNICATIONS” (step 230) is selected, the user sends or receives fax messages through the communications module 140. For receiving faxes, the receiving unit 140 first receives a fax message and then the editing module 130 decodes the message to restore the fax. For sending faxes, the editing module 130 encodes a fax message to be sent and the sending unit 142 sends out the fax message. The above-mentioned fax operation events are the most basic events of the invention.

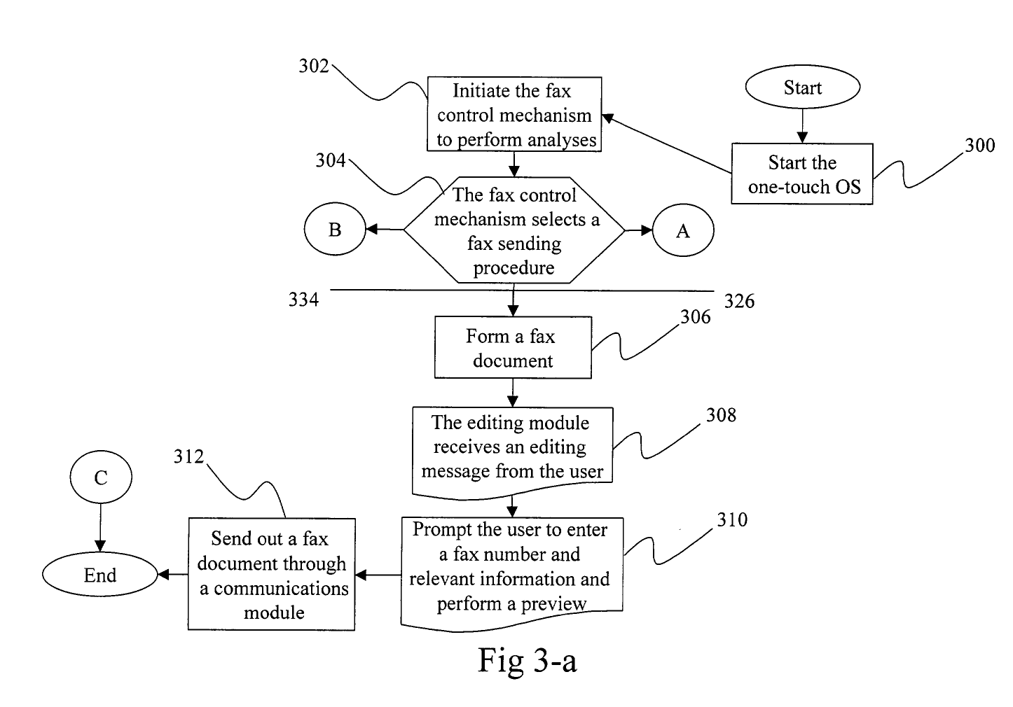

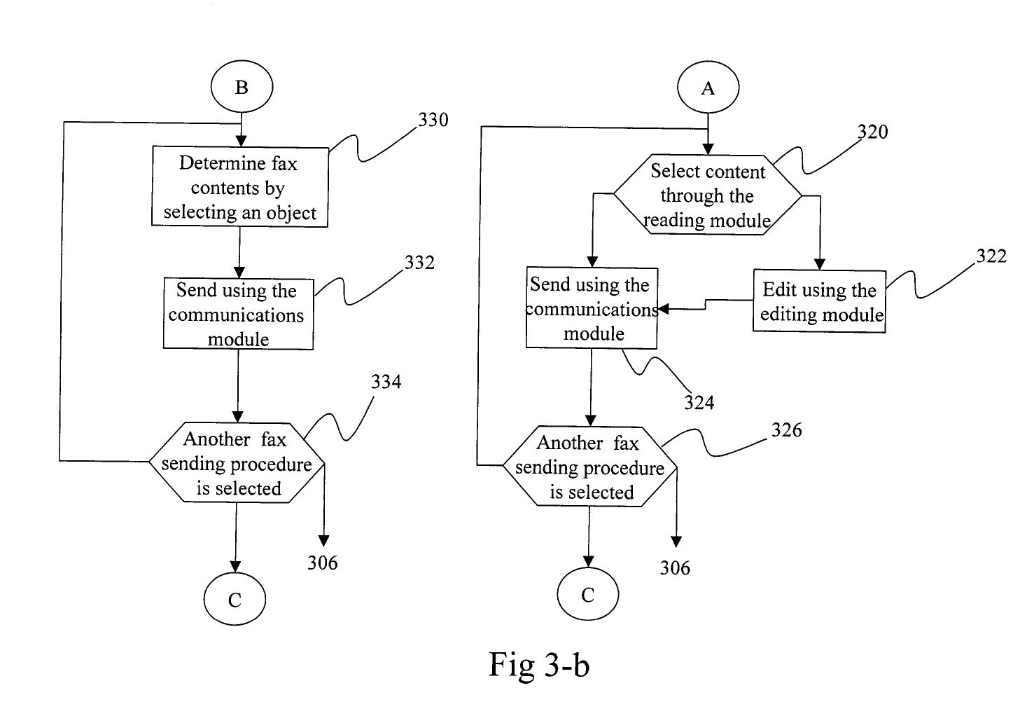

Referring to FIG. 3-a, the procedures of the main control function 112 are as follows:

First the one-touch OS 100 is initiated (step 300). A fax control mechanism 110 is then initiated (step 302) to determine whether there is a fax document and if so to analyze the type of the fax document. After the analysis, the fax control mechanism 110 selects a fax sending procedure (step 304). There are three types of fax sending procedures: (1) sending control procedure for a new fax, (2) sending control procedure for an existing fax, and (3) sending control procedure for appended contents from other applications. If the user selects the sending control procedure for a new fax, a fax document is first formed (step 306). The editing module 130 then receives an editing message from the user. After editing, the editing module 130 prompts the user to enter a fax number and other relevant information and generates a preview (step 310). Afterwards, the editing module 130 performs encoding on the fax message. Finally, the communications module 140 sends out the fax document (step 312).

After step 304 in FIG. 3-a, the procedure enters either step A or B in FIG. 3-b. If the sending control procedure for a new fax is selected, the reading module 120 selects contents after step A (step 320). If the user wants to edit or modify the contents, the editing module 130 is utilized (step 322), and the communications module 140 sends out the fax document (step 324). If the user does not want to edit, then step 324 is performed directly. Afterwards, another fax sending procedure is selected in step 326. If the user chooses to read other fax documents, then the procedure goes back to step 320. If the user chooses to create a new fax, then step 306 follows and the above-mentioned procedure for creating a new fax document is performed. If the user chooses to exit, the procedure ends.

If the sending control procedure for appended contents from other applications is selected, step B is followed by the step of selecting an object to determine the fax content (step 330). After selection, the communications module 140 sends out the fax document (step 332). Another fax sending procedure is selected in step 334. If the user chooses to add other objects in the fax document, then step 330 is repeated. If the user wants to create a new fax document, then step 306 is performed. If the user chooses to exit, then the procedure ends.

The files of the above-mentioned objects can be extracted from the texts of graphs in a text editor or a graph browser and copied to the fax document. The user can perform all these functions with a single action through the fax control mechanism of the one-touch OS 100.

In the current embodiment, the “single action” allowed for by the one-touch OS 100 means that the user needs only to press one key on the keyboard according to a selection menu to enter his request. Any key on the keyboard can be set to complete this kind of action. The keys include the number keys 0˜9, the letter keys A˜Z, the function keys F1˜F12 and special keys ESC, TAB, PgUp, END, etc. Aside from the keyboard, the single action request input can be accomplished using a mouse or other controllers, such as a digital touch-control panel or voice recognition system. That is, any basic computer input device can be used to provide one-touch control.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An auto fax sending and management system used in a one-touch OS (Operating System) on a computer controlled hardware platform for sending, receiving and management of fax documents monitored using a fax control mechanism, wherein the fax control mechanism comprises:
a reading module, which displays all received fax messages on a screen of the computer controlled hardware platform for the user to browse and presents a fax message selected by the user for the user to read;
an editing module, which decodes/encodes a received/sending document and enables the user to modify and edit the contents of the fax document;
a communications module, which is a communications interface between the fax control mechanism and external users and utilizes a server as its sending and receiving means, the communications module further including:
a receiving unit, which receives the fax document sent from an external user and calls the editing module to decode the received fax document;
a sending unit, which sends out the fax document prepared by the fax control mechanism and calls the editing module to encode the sending fax document; and
a input request module, which processes contents selected through another program and sends out the fax document through the sending unit after the encoding process.

2. The system of claim 1, wherein the one-touch OS is an OS that enables the user to complete a function provided in the work group displayed in a UOI (User Operating Interface) in a single action.

3. The system of claim 2, wherein the work group comprises of at least one function item.

4. The system of claim 2, wherein the single action refers to the action that the user follows a selection menu generated by the UOI to perform controls using a basic I/O (Input/Output) device provided by the computer controlled hardware platform.

5. The system of claim 4, wherein the basic I/O device is selected from the group comprising a keyboard, a mouse, a digital touch-control panel and a voice recognition system.

6. The system of claim 2, wherein the UOI generates at least one set of the work group.

7. The system of claim 1, wherein the one-touch OS is able to operate with other different OS's and the user determines to switch among the different OS's.

8. The system of claim 1, wherein the one-touch OS operates alone.

9. The system of claim 1, wherein the computer controlled hardware platform is selected from the group comprising a PC (Personal Computer), an NB (Notebook), and a PDA (Personal Digital Assistant).

10. An auto fax sending and management method used in a one-touch OS for sending, receiving and managing fax documents, through a UOI linking a user and server and monitored using a fax control mechanism, the method comprising the steps of:
starting the one-touch OS;
employing the fax control mechanism to perform analyses;
selecting a fax sending procedure through the fax control mechanism;
forming a fax document;
receiving editing message from the user through an editing module;
prompting the user to enter a fax number and relevant information and previewing them; and
sending the fax document through a communications module.

11. The method of claim 10, wherein the step of selecting a fax sending procedure through the fax control mechanism further includes: a sending control procedure for an existing fax, and a sending control procedure for appended contents from other applications.

12. The method of claim 11, wherein the sending control procedure for an existing fax comprises the steps of:
selecting contents through a reading module; and
selecting a next fax sending procedure.

13. The method of claim 12, wherein the step of selecting contents through the reading module further comprises the steps of:
editing using the editing module; and
sending using the communications module.

14. The method of claim 11, wherein the sending control procedure for appended contents from other applications comprises the steps of:
determining fax contents by selecting an object;
sending using the communications module; and
selecting a next fax sending procedure.

15. The method of claim 14, wherein the object is selected from the combination of texts and graphs in a text editor and a graph browser and is added to the fax document.

16. The method of claim 11, wherein the fax sending procedure for an existing fax and the fax sending procedure for appended contents from other applications are monitored by the one-touch OS so that any command and request is executed through one single action.

17. The method of claim 16, wherein the single action refers to the action that the user follows a selection menu generated by the UOI to perform controls using a basic I/O (Input/Output) device provided by the computer controlled hardware platform.

18. The method of claim 17, wherein the basic I/O device is selected from the group comprising a keyboard, a mouse, a digital touch-control panel and a voice recognition system.
